(19) United States
(12) Patent Application Publication
(10) Pub. No.: US 2008/0205433 A1
(43) Pub. Date: Aug. 28, 2008

(54) Method for immediate access to a random access channel

(75) Inventors: Juha Pihlaja, Helsinki (FI); Juha Korhonen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/978,155

(22) Filed: Oct. 25, 2007

Related U.S. Application Data
(60) Provisional application No. 60/855,070, filed on Oct. 26, 2006.

(51) Int. Cl. H04L 12/43

(52) U.S. Cl. 370/461

(57) ABSTRACT

A method is provided for transmitting a message comprising one or more preambles and a message body from a user equipment device to a network entity. The method includes determining whether it is allowed to transmit a first preamble of the message to the network entity in an immediately available time slot of a random access channel, transmitting the first preamble if it is allowed, and transmitting the message body if a positive acknowledgement to the preamble is received from the network entity on another channel. The user equipment device may determine transmitting the preamble invariably, based on a persistence value or an indication received from the network entity, based on whether the device has not transmitted on the random access channel for longer than a predetermined, or based on whether the device has not transmitted on the random access channel for longer than a random time period.

### CROSS REFERENCE TO RELATED APPLICATIONS

This application claims priority to a provisional patent application Ser. No. 60/855,070 filed at the United States Patent and Trademark Office on Oct. 26, 2006, the contents of which is hereby incorporated by reference in its entirety.

### TECHNICAL FIELD

The present invention relates generally to an access method in a mobile communication system. In particular, the present invention relates to a method for accessing a random access channel (RACH) in packet based mobile communication networks. Examples of such networks include universal terrestrial radio access network (UTRAN) and evolved universal terrestrial radio access network (E-UTRAN).

### BACKGROUND ART

The present invention concerns procedures for accessing a random access channel (RACH), used during the initial access to a mobile communication network. The RACH is a common transport channel for initial uplink transmission from a mobile terminal (also known as user equipment (UE) device or wireless communication device) to a network entity such as a base station (also known as a Node B). The RACH function is different depending on the technology used in the communication network. In this application, RACH access in frequency division duplexing (FDD) mode in E-UTRAN according to long term evolution (LTE) of the Third Generation Partnership Project (3GPP) specifications is exemplified and the corresponding procedure(s) in UTRAN is referenced.

The transport channel RACH is carried by a physical random access channel (PRACH). A random access transmission is accomplished on the RACH in conjunction with a downlink indicator channel that carries acquisition indicator signals. The random access transmission normally uses a “slotted ALOHA” technique. That means a UE can start a random access transmission on the RACH at the beginning of a number of time intervals, denoted as access slots. A RACH message is composed by one or more preambles and a message body. The length and interval of the access time slots and the lengths of the RACH preamble and the message body are specified in respective network specifications. For example, in UTRAN, there are 15 RACH access slots per two frames and they are spaced 5120 chips apart. A RACH preamble is 4096 chips long and a message body is 10 or 20 ms long. In the not-yet-finalized E-URTAN, the density of the access time slots has not yet been decided. The structure of the RACH message may also be different from that of the UTRAN. In a basic configuration, for example, the length of the preamble may be 1 ms that includes the preamble sequence, its cyclic prefix and a guard time.

RACH is a contention-based channel. Several UEs may access one RACH time slot at same time and result in a collision. Therefore, a transmission by a UE may not be successful in the first try. A solution aimed to resolve the conflicts, so that all messages are eventually transmitted successfully, is presented in the 3GPP specifications for UTRAN. The solution is a procedure based on a so-called persistence test. (Reference: 3rd Generation Partnership Project; Technical Specification Group Radio Access Network; Medium Access Control (MAC) Protocol Specification, Release 7, 3GPP TS 25.321 V7.1.0, 2006-06) However, because one or more persistence tests are required for every UE at beginning of every RACH transmission, regardless of the network conditions, the procedure may cause an unnecessary waiting time for a UE.

Therefore, what is needed is a modified procedure for the RACH access that allows the UE to bypass the persistence tests under certain conditions or always. By bypassing the persistence tests, the UE may start a RACH transmission immediately when a need to transmit emerges.

Accordingly, what is also needed is an apparatus so equipped for performing the modified procedure, and a network entity that facilitates the execution of the modified procedure and accepts the RACH transmission from the apparatus according to the modified procedure.

### SUMMARY OF THE INVENTION

In a first aspect of the invention, a method is provided for transmitting a message from a user equipment device to a network entity. The message comprises one or more preamble and a message body. The method comprises determining whether it is allowed to transmit a first preamble of the message to the network entity in an immediately available access time slot of a random access channel, transmitting the first preamble if the transmission is allowed, and transmitting the message body if a positive acknowledgment to the first preamble is received from the network entity on another channel.

In the method, the determining whether it is allowed to transmit the first preamble may include allowing to transmit the first preamble invariably.

Alternatively, the determining whether it is allowed to transmit the first preamble may include allowing to transmit the first preamble if the user equipment device has not transmitted on the random access channel for longer than a predetermined time period.

Alternatively, the determining whether it is allowed to transmit the first preamble may include allowing to transmit the first preamble if the user equipment device has not transmitted on the random access channel for a number of access time slots of the random access channel that is greater than a predetermined number.

The method may further comprise generating a random time period. The determining whether it is allowed to transmit the first preamble may include allowing to transmit the first preamble if the user equipment device has not transmitted on the random access channel for longer than the random time period.

Alternatively, the method may further comprise generating a random integer. The determining whether it is allowed to transmit the first preamble may include allowing to transmit the first preamble if the user equipment device has not transmitted on the random access channel for a number of access time slots of the random access channel that is greater than the random integer.

The method may further comprise receiving a persistence value from the network entity. The determining whether it is allowed to transmit the first preamble may include allowing to transmit the first preamble if the received persistence value is larger than a predetermined persistence value.

Alternatively, the method may further comprise receiving an indicator from the network entity. The determining whether it is allowed to transmit the first preamble may include determining whether it is allowed to transmit the first preamble based on the indicator.

The method may further comprise performing one or more preparatory persistence tests prior to determining whether it is allowed to transmit the first preamble. A parameter may be determined by the one or more preparatory persistence tests. The determining whether it is allowed to transmit the first preamble may include determining whether it is allowed to transmit the first preamble based on the parameter.

The above one or more preparatory persistence tests may comprise setting the parameter as not allowing transmitting the first preamble, generating a random number, comparing the random number with a predetermined persistence value, setting the parameter as allowing transmitting the first preamble if the random number is less than the predetermined persistence value, and repeating generating the random number and comparing with the predetermined persistence value for each access time slot of the random access channel if no message needs to be transmitted.

In a second aspect of the invention, an apparatus capable of transmitting a message to a network entity is provided. The message comprises one or more preamble and a message body. The apparatus comprises a processor for determining whether it is allowed to transmit a first preamble of the message to the network entity in an immediately available access time slot of a random access channel, a transmitter for transmitting the first preamble if the transmission is allowed and transmitting the message body if a positive acknowledgement to the first preamble is received, and a receiver for receiving the acknowledgement from the network entity on another channel.

The processor of the apparatus may be configured to allow transmitting the first preamble invariably.

Alternatively, the processor of the apparatus may be configured to allow transmitting the first preamble if the apparatus has not transmitted on the random access channel for longer than a predetermined time period.

Alternatively, the processor of the apparatus may be configured to allow transmitting the first preamble if the apparatus has not transmitted on the random access channel for a number of access time slots of the random access channel that is greater than a predetermined number.

The apparatus may further comprise a random number generator for generating a random time period. The processor of the apparatus may be configured to allow transmitting the first preamble if the apparatus has not transmitted on the random access channel for longer than the random time period.

Alternatively, the apparatus may further comprise a random number generator for generating a random integer. The processor of the apparatus may be configured to allow transmitting the first preamble if the apparatus has not transmitted on the random access channel for a number of access time slots of the random access channel that is greater than the random integer.

The receiver of the apparatus may be configured to receive a persistence value from the network entity. The processor of the apparatus may be configured to allow transmitting the first preamble if the received persistence value is larger than a predetermined persistence value.

Alternatively, the receiver of the apparatus may be configured to receive an indicator from the network entity. The processor of the apparatus may be configured to determine whether it is allowed to transmit the first preamble based on the indicator.

Further, the processor of the apparatus may be configured to perform one or more preparatory persistence tests prior to determining whether it is allowed to transmit the first preamble. A parameter may be determined by the one or more preparatory persistence tests. The processor of the device may be configured to determine whether it is allowed to transmit the first preamble based on the parameter.

The apparatus may further comprise a random number generator. The one or more preparatory persistence tests may comprise setting the parameter as not allowing transmitting the first preamble, generating a random number by the random number generator, comparing the random number with a predetermined persistence value, setting the parameter as allowing transmitting the first preamble if the random number is less than the predetermined persistence value, and repeating generating the random number and comparing with the predetermined persistence value for each access time slot of the random access channel if no message needs to be transmitted.

The apparatus may be a user equipment device. The user equipment device may be a wireless communication device.

In a third aspect of the invention, a network entity is provided for receiving a message from a user equipment device. The message comprises one or more preambles and a message body. The network entity comprises a processing device configured to set a parameter according to one or more conditions of the random access channel, a receiver for receiving a first preamble of the message on a random access channel and for receiving the message body after an acknowledgement to the first preamble, and a transmitter for transmitting the parameter as a part of a system information broadcast and transmitting to the user equipment device the acknowledgement of the first preamble on another channel. The user equipment device is configured to determine whether it is allowed to transmit the first preamble in an immediately available access time slot of the random access channel based on the parameter.

In the network entity, the parameter may be a persistence value set according to one or more conditions of the random access channel, and the user equipment device may be configured to allow transmitting the first preamble if the persistence value is larger than a predetermined persistence value.

In the network entity, the parameter may be an indicator set according to one or more conditions of the random access channel, and the user equipment device may be configured to determine whether to transmit the first preamble based on the indicator.

The network entity may be a radio resource controller of a base station.

In a fourth aspect of the invention, a computer program product is provided. The product comprises a computer readable storage medium with program codes stored thereon for using in an apparatus for transmitting a message to a network entity. The message comprises one or more preambles and a message body. The program codes comprise instructions for determining whether it is allowed to transmit a first preamble of the message to the network entity in an immediately available access time slot of a random access channel, instructions for transmitting the first preamble if the transmission is allowed, and instructions for transmitting the message body if a positive acknowledgement to the preamble is received from the network entity on another channel.

The instructions for determining whether it is allowed to transmit the first preamble may comprise instructions for allowing to transmit the first preamble invariably.

Alternatively, the instructions for determining whether it is allowed to transmit the first preamble may comprise instructions for allowing to transmit the first preamble, if the apparatus has not transmitted on the random access channel for longer than a predetermined time period, or if the apparatus has not transmitted on the random access channel for a number of access time slots of the random access channel that is greater than a predetermined number.

Alternatively, the program codes may further comprise instructions for generating a random time period or a random integer. The instructions for determining whether it is allowed to transmit the first preamble may comprise instructions for allowing to transmit the first preamble, if the apparatus has not transmitted on the random access channel for longer than the random time period, or if the apparatus has not transmitted on the random access channel for a number of access time slots of the random access channel that is greater than the random integer.

The program codes may further comprise instructions for receiving a persistence value or an indicator from the network entity. The instructions for determining whether it is allowed to transmit the first preamble may comprise instructions for allowing to transmit the first preamble if the received persistence value is larger than a predetermined persistence value or for determining whether to transmit the first preamble based on the indicator.

The program code may further comprise instructions for performing one or more preparatory persistence tests prior to determining whether it is allowed to transmit the first preamble. A parameter may be determined by the one or more preparatory persistence tests. The instructions for determining whether it is allowed to transmit the first preamble may comprise instructions for determining whether it is allowed to transmit the first preamble based on the parameter.

The above instructions for performing one or more preparatory persistence tests may comprise instructions for setting the parameter as not allowing transmitting the first preamble, instructions for generating a random number, instructions for comparing the random number with a predetermined persistence value, instructions for setting the parameter as allowing transmitting the first preamble if the random number is less than the predetermined persistence value, and instructions for repeating generating the random number and comparing with the predetermined persistence value for each access time slot of the random access channel if no message needs to be transmitted.

In a fifth aspect of the invention, an apparatus is provided. The apparatus is capable of transmitting a message to a network entity. The message comprises one or more preambles and a message body. The apparatus comprises means for determining whether it is allowed to transmit a first preamble of the message to the network entity in an immediately available access time slot of a random access channel, means for transmitting the first preamble if the transmission is allowed, means for receiving an acknowledgement to the preamble from the network entity on another channel, and means for transmitting the message body if the acknowledgement is a positive acknowledgement.

The means for determining whether it is allowed to transmit the first preamble may be configured to allow transmitting the preamble invariably.

Alternatively, the means for determining whether it is allowed to transmit the first preamble may be configured to allow transmitting the first preamble if the apparatus has not transmitted on the random access channel for longer than a predetermined time period or for a number of access time slots of the random access channel that is greater than a predetermined number.

The apparatus may further comprise means for generating a random time period or a random integer. The means for determining whether it is allowed to transmit the first preamble may be configured to allow transmitting the first preamble if the apparatus has not transmitted on the random access channel for longer than the random time period or for a number of access time slots of the random access channel that is greater than the random integer.

The apparatus may further comprise means for receiving a persistence value or an indicator from the network entity. The means for determining whether it is allowed to transmit the first preamble may be configured to allow transmitting the first preamble if the received persistence value is larger than a predetermined persistence value or is configured to determine whether it is allowed to transmit the first preamble based on the indicator.

The apparatus may further comprise means for performing one or more preparatory persistence tests prior to determining whether it is allowed to transmit the first preamble. A parameter may be determined by the one or more preparatory persistence tests. Whether it is allowed to transmit the first preamble may be determined based on the parameter.

In a sixth aspect of the invention, a network entity is provided for receiving a message from a user equipment device. The message comprises one or more preambles and a message body. The network entity comprises means for setting a parameter according to one or more conditions of the random access channel, means for transmitting the parameter as a part of a system information broadcast, means for receiving a first preamble of the message on a random access channel, means for transmitting to the user equipment device the acknowledgement of the first preamble on another channel, and means for receiving the message body after an acknowledgement to the first preamble. The user equipment device is configured to determine whether it is allowed to transmit the first preamble in an immediately available access time slot of the random access channel based on the parameter.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a flow diagram of an exemplary RACH access procedure;

FIG. 2 is a flow diagram of an exemplary persistence test and PRACH transmission procedure;

FIG. 3 is a flow diagram of an immediate RACH access procedure according to a first embodiment of the invention;

FIG. 4 is a flow diagram of an immediate RACH access procedure according to a second embodiment of the invention;

FIG. 5 is a flow diagram of an immediate RACH access procedure according to a third embodiment of the invention;

FIG. 6 is a flow diagram of an immediate RACH access procedure according to a fourth embodiment of the invention;

FIG. 7 is a flow diagram of an immediate RACH access procedure according to a fifth embodiment of the invention; and

FIG. 8 is a block diagram of a system comprising a user equipment device and a network entity according to the invention.

### DETAILED DESCRIPTION OF THE INVENTION

In a user equipment (UE) device such as a mobile terminal, accessing the RACH for data transmission is controlled by a medium access control (MAC). MAC is a sub-layer of a data link layer of the user-plane protocol stack of the UE. MAC sits between a physical layer (layer 1, the lowest layer) and a radio link control (RLC) sub-layer of the data link layer (layer 2).

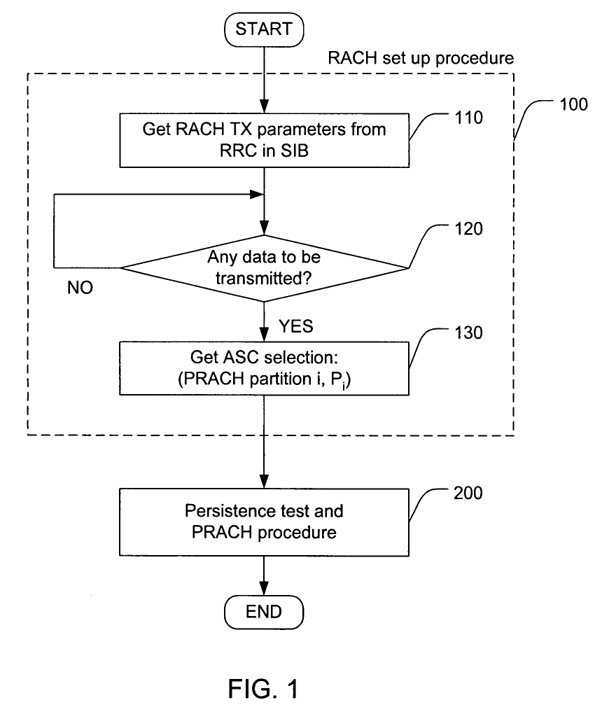

Referring now to FIG. 1, an exemplary RACH transmission procedure comprises a RACH set up procedure 100 and a persistence test and PRACH transmission procedure 200. In the RACH set up procedure 100, the MAC receives system information broadcast (SIB) from a radio resource controller (RRC) (step 110). The SIB includes one or more RACH transmission parameters for the UE to set up the RACH transmission. The RACH transmission parameters include a maximum number of preamble ramping cycle (Mₘₐₓ) and a set of access service class (ASC) parameters. In a step 120, the UE waits for a need for transmitting data on the RACH to emerge. When the need has emerged, in a step 130, the MAC selects (or the RRC assigns) an ASC from the available set of ASCs. Selection of the ASC may be based on the priority or reason for the random access. The ASC parameters the MAC received from the RRC include an identifier i of a certain PRACH partition and an associated persistence value Pᵢ (0≦Pᵢ<1).

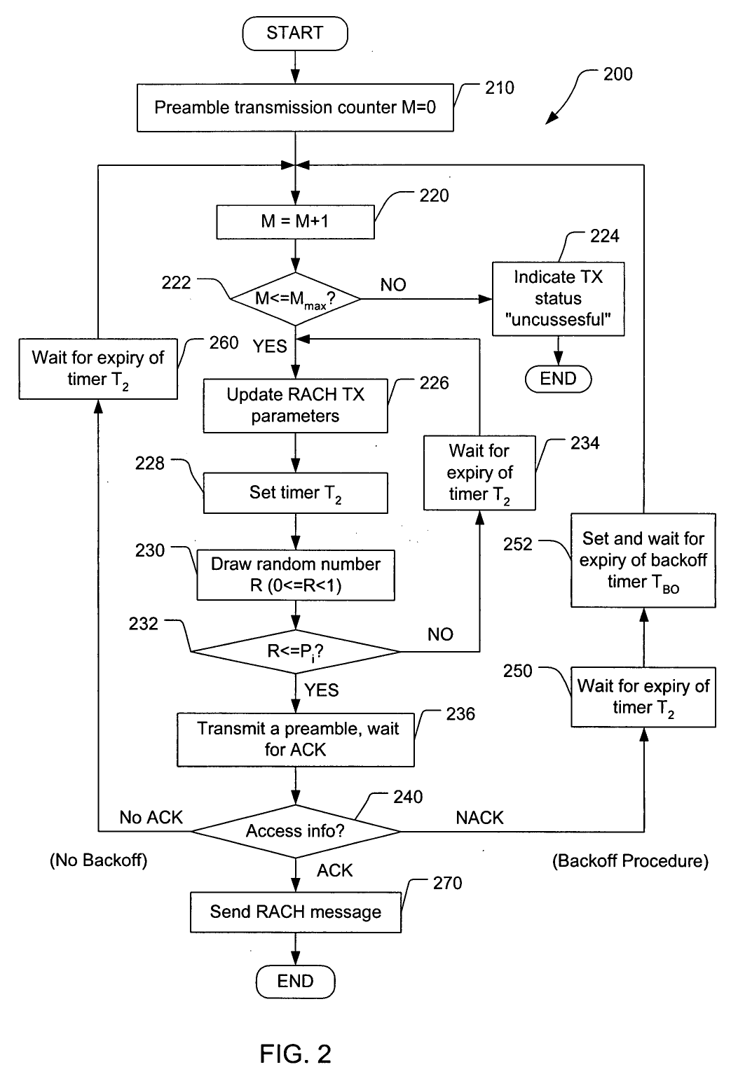

After completion of the RACH set up procedure 100, the UE then initiates a RACH transmission according to the persistence test and PRACH transmission procedure 200. An exemplary flow diagram of the procedure 200 is shown in FIG. 2.

Referring now to FIG. 2, the UE is required to perform one or more persistence tests to decide whether to transmit a RACH preamble in the present assess time slot. In a step 210, a preamble transmission cycle count M is set to zero. In a next step 220, the cycle count M is increased by 1. In a next step 222, the MAC decides whether the current count M has exceeded the maximum allowable preamble ramping cycle, Mₘₐₓ. If M>Mₘₐₓ, the maximum number of preamble ramping cycle has been reached and, in a step 224, the MAC informs a higher layer that originated the RACH transmission that the RACH transmission procedure is unsuccessful, and the RACH procedure 200 ends at this point. The higher layer may decide whether to restart the RACH transmission or give up.

If M<Mₘₐₓ, the maximum number of preamble ramping cycle has not been reached. In a step 226, the MAC checks for update of the RACH transmission control parameters, and the RACH procedure continues with the following actions known as a persistence test.

In a step 228, a timer T₂ is set. The length of the timer is from the current access slot to the next access slot allocated for transmitting a preamble. Should this persistence test fail, this timer ensures that a subsequent persistence test is not performed before the arrival of the next access slot. In a step 230, a random number R (0≦R≦1) is generated. In a step 232, the number R is compared with the persistence value Pᵢ of the selected ASC. If R>Pᵢ, the persistence test fails. In a step 234, the MAC must wait for the timer T₂ to expire before performing another persistence test. The persistence test is repeated until one of the tests succeeds (R≦Pᵢ). Upon passing the persistence test, in a step 236, the UE transmits a RACH preamble at the current time slot.

After the transmission of the preamble, the MAC waits for a response on the downlink indicator channel. In a step 240, if a positive acknowledgement (ACK) was received, the RACH message body may be sent in an allocated time slot for transmitting the message (step 270). If the RACH were busy, a negative acknowledgement (NACK) would be received. In this case the MAC should initiate a back-off procedure as follows:
1. If the timer T₂ has not expired, wait for its expiry (step 250);
2. Set a back-off timer TBO and wait for its expiry (step 252); at this point, another preamble ramping cycle may start (returning to the step 220).

If no response was received (no ACK), the MAC waits for the expiry of timer T₂ (step 260) and starts another preamble ramping cycle (returning to step 220). No back-off procedure is performed.

By adjusting the value of Pᵢ and changing the rate of RACH time slots, the network is able to keep the collisions on RACH at an acceptable level. However, because the persistence test is required for every UE at beginning of every RACH transmission, this RACH access procedure may sometimes result in an unnecessary waiting time for a UE.

The above-described procedure may be differently arranged depending on the system. In UTRAN system, for example, more than one preamble may be transmitted in the step 236 that involves actions of the physical layer. The MAC of UTRAN operates at the time resolution of a radio frame (10 ms) while several RACH access slots exist during one radio frame. Therefore, it has been reasonable to specify that the physical layer can be configured to send more than one preamble between the MAC actions like the persistence test (steps 230 and 232). MAC of E-UTRAN, on the other hand, operates with the same time resolution that is used for determining the access slots of RACH. Then MAC can instruct the physical layer for each preamble transmission and step 236 involves transmission of only one preamble.

This invention provides a modification to the above-described RACH access procedure, namely an immediate RACH access procedure. The immediate RACH access procedure according to this invention allows a UE to bypass an initial persistence test under certain conditions or always. The invention is disclosed in the following exemplary embodiments.

### FIRST EMBODIMENT OF THE INVENTION

In this embodiment of the invention, the UE is configured to transmit a preamble immediately after a need to transmit on RACH has emerged. If the transmission was successful (indicated by an ACK message), the UE can then transmit the message body at an allocated time slot. Therefore, a possible delay due to the persistence test may be avoided.

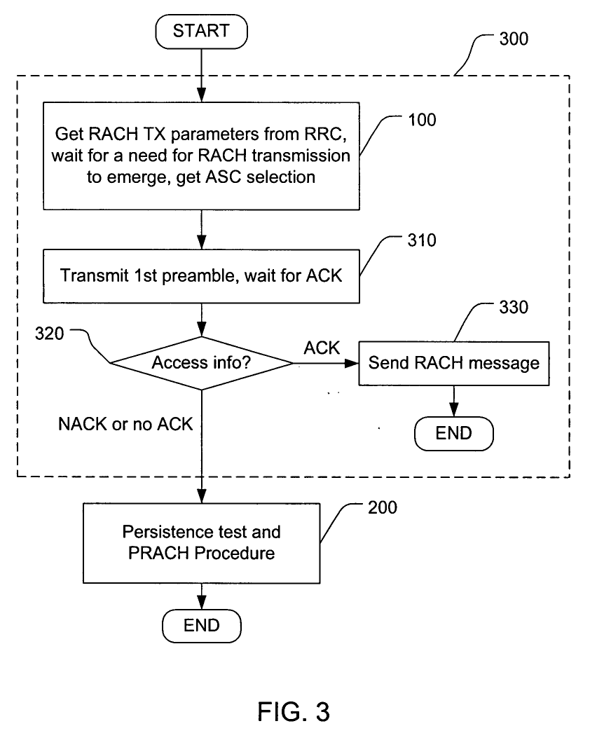

Referring now to FIG. 3, the immediate RACH access procedure according to this embodiment of the invention comprises a modified RACH set up procedure 300 and the persistence test and PRACH transmission procedure 200.

In the modified RACH set up procedure 300, the first few steps are the same as in the above-described RACH setup procedure 100, i.e. the MAC receives system information broadcast (SIB) from a RRC, the UE waits for a need for transmitting data on the RACH to emerge, and when the need has emerged, the MAC selects an ASC from the available set of ASCs. Additionally, in a step 310, the first preamble of the RACH message is transmitted immediately at a time slot that is allocated for transmitting the RACH preamble, and the MAC waits for a response on the downlink indicator channel.

At a step 320, the MAC determines if the response from the downlink indicator channel is a positive acknowledgement (ACK), a negative acknowledgement (NACK) or no acknowledgement (no ACK). If there is an ACK, a time slot is allocated for transmitting the message body. In a step 330, the MAC transmits the RACH message in the time slot, reports to the higher layer that originated the RACH transmission that the transmission was successful and the immediate RACH access procedure ends. Otherwise, if there is a NACK (i.e. the channel is busy) or no response from the channel (no ACK), the MAC initiates the persistence test and PRACH transmission procedure 200 as described previously.

This embodiment takes into account that, naturally, all UEs of a network have a random timing in attempting accesses to the RACH. The need to transmit from different UEs will occur at different times depending either on downlink activities or users' actions.

Thus, the need to randomize the transmission time among the UEs is at least partially fulfilled by the randomness of the timing in the UEs themselves. In fact, the probability for two or more UEs to start transmissions on the RACH using the same RACH time slot is naturally low. Even if a collision does occur and the transmissions fail, the involved UEs will be informed (either by a NACK message from the network or a lack of acknowledgement from the network). If the first preamble transmissions fail due to the collision, the UEs start a second attempt according to the above-described persistence test and PRACH transmission procedure 200. Eventually, because the persistence tests may place different UEs in different transmission time slots, all the UEs will be allowed to transmit on the RACH, albeit in different time slots.

### SECOND EMBODIMENT OF THE INVENTION

According to this embodiment of the invention, the UE is able to determine whether to allow an immediate RACH transmission without performing the persistence test. The determination may be based on one or more conditions already known to the UE.

In other words, the UE is allowed to transmit the first preamble of the RACH message if the time lapse (T) since the last RACH transmission by the same UE is longer than a predetermined time period (T_{B}), or the number of RACH time slots passed (N) since the last RACH transmission by the same UE is more than a predetermined number of RACH time slots (N_{B}).

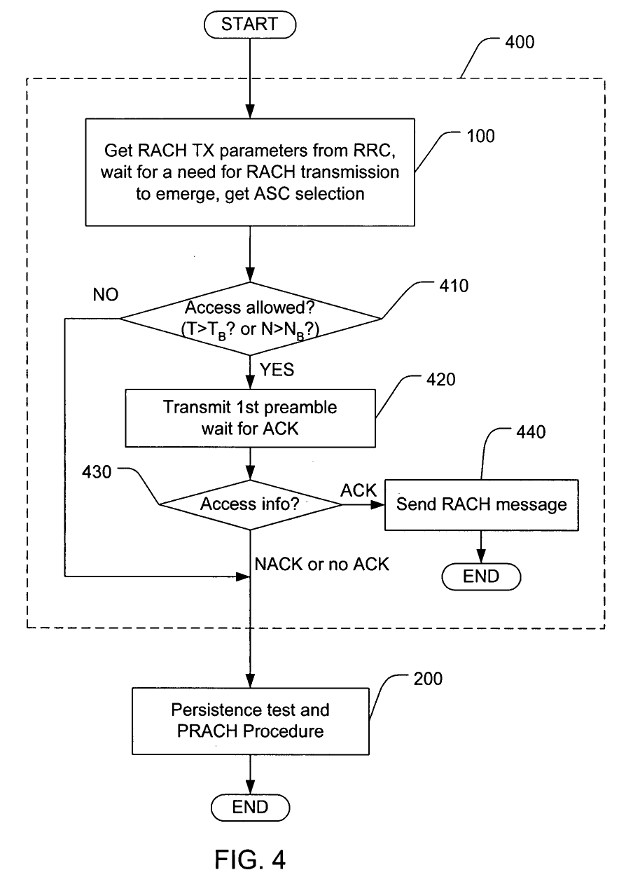

Referring now to FIG. 4, the immediate RACH transmission procedure according to this embodiment of the invention comprises a modified RACH set up procedure 400 and the persistence test and PRACH transmission procedure 200.

In the modified RACH set up procedure 400, the first few steps are the same as in the above-described RACH setup procedure 100, i.e. the MAC receives system information broadcast (SIB) from a RRC, the UE waits for a need for transmitting data on the RACH to emerge, and when the need has emerged, the MAC selects an ASC from the available set of ASCs. Additionally, in a step 410, the value T or N is compared with the predetermined time period T_{B} or predetermined number of time slots N_{B}, respectively. If T or N is greater than the predetermined time period T_{B} or the predetermined number of slots N_{B}, respectively, the immediate access is allowed and the persistence test may be skipped if the immediate access is successful.

Then, in a step 420, the first preamble of the RACH message is transmitted at the immediately available time slot that is allocated for transmitting a preamble, and the MAC waits for a response on the downlink indicator channel. In a step 430, the MAC determines if the response from the downlink indicator channel is a positive acknowledgement (ACK), a negative acknowledgement (NACK) or no acknowledgement (no ACK). If there is an ACK, a time slot is allocated for transmitting the message body. In a step 440, the MAC transmits the RACH message body, reports to the higher layer that originated the RACH transmission that the transmission was successful and the immediate RACH access procedure ends. Otherwise, if there is a NACK (i.e. the channel is busy) or no response from the channel (no ACK), the MAC initiates the persistence test and PRACH transmission procedure 200.

After the above step 410, if T or N is less than or equal to the predetermined time period T_{B} or the predetermined number of slots N_{B}, respectively, the persistence test cannot be skipped, the MAC initializes a persistence test and PRACH transmission procedure 200.

The predefined values T_{B} or N_{B} can be stored in the UE and may be adjustable. For example, if T_{B} (or N_{B}) is set to be zero, the UE can always start RACH transmission immediately without the persistence test (same as the first embodiment of the invention).

This embodiment of the invention is different from the first embodiment of the invention in that one or more conditions must be met in order for the UE to skip the first persistence test. These conditions are predefined.

### THIRD EMBODIMENT OF THE INVENTION

According to the third embodiment of the invention, the UE is able to determine whether to it is allowed to transmit the first preamble of the RACH message without performing the persistence test. The determination is based on a random condition and, therefore, the result may vary depending on the condition.

In other words, the UE may start a first preamble transmission on the RACH if the time lapse (T) since the last RACH transmission by the same UE is longer than a random period of time T_{R}, or the number of RACH time slots passed (N) since the last RACH transmission by the same UE is more than a random number of RACH time slots N_{R}. T_{R} may be a random value between 0 and a maximum value T_{Rmax}. N_{R} may be a random integer between 0 and a maximum number N_{Rmax}.

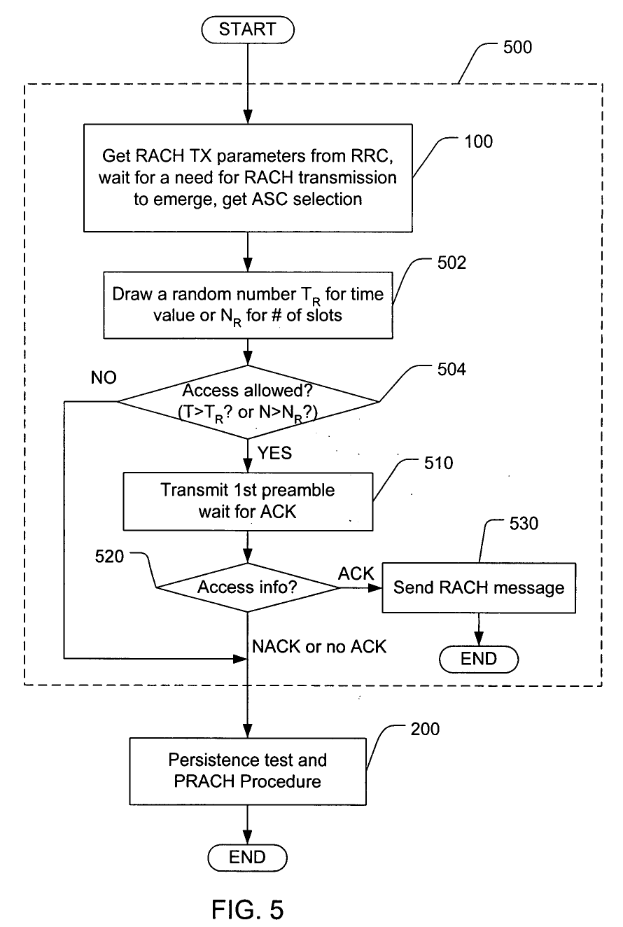

Referring now to FIG. 5, the immediate RACH transmission procedure according to this embodiment of the invention comprises a modified RACH set up procedure 500 and the persistence test and PRACH transmission procedure 200.

In the modified RACH set up procedure 500, the first few steps are the same as in the above-described RACH setup procedure 100, i.e. the MAC receives system information broadcast (SIB) from a RRC, the UE waits for a need for transmitting data on the RACH to emerge, and when the need has emerged, the MAC selects an ASC from the available set of ASCs. Additionally, in a step 502, a random time value T_{R} (0≦T_{R}<T_{Rmax}) or a random integer N_{R} (0≦N_{R}≦N_{Rmax}) is drawn. In a step 504, the random value T_{R} or N_{R} is compared with the time lapse since the last RACH transmission by the same UE, either in time value T or in number of RACH time slots N. If T>T_{R} or N>N_{R} (YES), the persistence test can be skipped.

Then, in a step 510, the first preamble of the RACH message is transmitted at an immediate available time slot that is allocated for transmitting a preamble, and the MAC waits for a response on the downlink indicator channel. In a step 520, the MAC determines if the response from the downlink indicator channel is a positive acknowledgement (ACK), a negative acknowledgement (NACK) or no acknowledgement (no ACK). If there is an ACK, a time slot is allocated for transmitting the message body.

In a step 530, the MAC transmits the RACH message body at the time slot that is allocated for the RACH message body, reports to the higher layer that originated the RACH transmission that the transmission was successful and the immediate RACH access procedure ends. Otherwise, if there is a NACK (i.e. the channel is busy) or no response from the channel (no ACK), the MAC initiates the persistence test and PRACH transmission procedure 200.

After the above step 502, if T≦T_{R} or N≦N_{R} (NO), the persistence test cannot be skipped, the MAC initializes a persistence test and PRACH transmission procedure 200.

This embodiment of the invention is different from the second embodiment of the invention in that the conditions for skipping the first persistence test are not predefined.

### FOURTH EMBODIMENT OF THE INVENTION

It would be even more desirable if the immediate RACH access procedure takes into account the network conditions at the time of attempting the RACH access. For example, if the network has a high load, the probability of two or more UEs interfere on the RACH would be relatively high. In this case, the RACH access procedure based on the persistence test would be more appropriate. Therefore, it would be desirable for the network to be able to instruct the UEs not to skip the required persistence test if, for example, the network notices that the load on RACH suddenly increases significantly.

According to the fourth embodiment of the invention, the UE is able to determine whether to attempt an immediate RACH transmission without performing the persistence test. The determination may be based on an instruction or indication from the network or one or more of the conditions known to the UE.

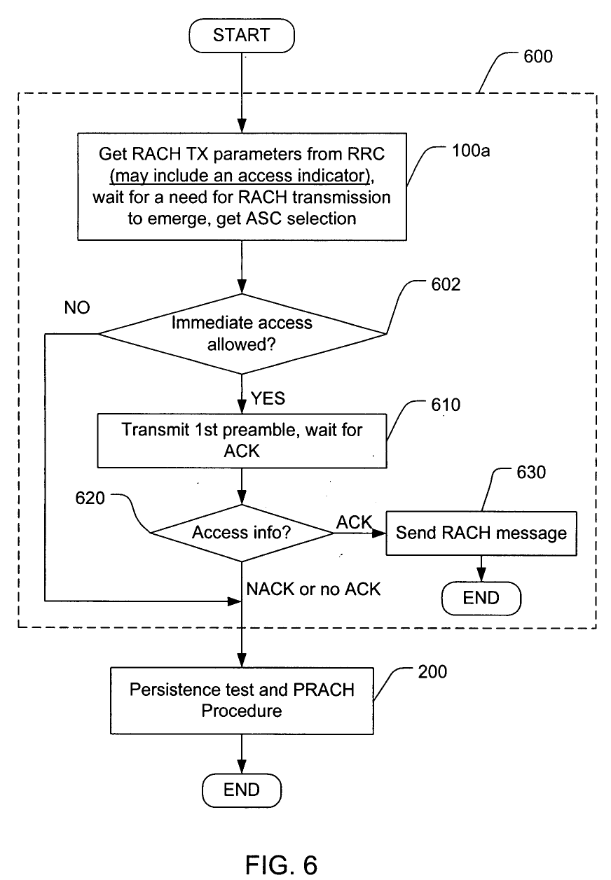

Referring now to FIG. 6, an immediate RACH transmission procedure according to this embodiment of the invention comprises a modified RACH set up procedure 600 and the persistence test and PRACH transmission procedure 200.

The modified RACH set up procedure 600 comprises a set up procedure 100a. The procedure 100a is the same as the above-described RACH setup procedure 100, except that the RACH transmission parameters in SIB may additionally include an access indicator, such as a signal or a parameter, that can be used by the UE for deciding whether to perform the persistence test before the first RACH preamble transmission. After completing the set up procedure 100a, in a next step 602, the MAC decides whether to perform the persistence test according to the persistence test and PRACH transmission procedure 200, or start the first RACH preamble transmission without perform the persistence test. If the immediate access is allowed (YES), in a step 610, a RACH preamble is transmitted at the next time slot allocated for transmitting the preamble, and MAC waits for a response on the downlink indicator channel. At a step 620, the MAC determines if the response from the downlink indicator channel is a positive acknowledgement (ACK), a negative acknowledgement (NACK) or no acknowledgement (no ACK). If there is an ACK, a time slot is allocated for transmitting the message body. In a step 630, the MAC transmits the RACH message at the time slot that is allocated for the RACH message, reports to the higher layer that originated the RACH transmission that the transmission was successful and the immediate RACH access procedure ends. Otherwise, if there is a NACK (i.e. the channel is busy) or no response from the channel (no. ACK), the MAC initiates the persistence test and PRACH transmission procedure 200.

Form the above step 602, if the immediate access is not allowed (NO), the MAC initiates the persistence test and PRACH transmission procedure 200.

The decision of whether or not to allow immediately RACH access in the step 602 is based on an indication that may be related to the network conditions or to the UE conditions. The indication may be one of the following:
(1) An indicator, such as a signal or a parameter, included in the SIB that the network broadcasts to all UEs;
(2) Conditions known to the UE, and the UE is configured to determine whether to skip the initial persistence test based on one or more of the conditions.

The indicator included in the SIB directs the UEs whether or not to make an immediate access to the RACH. For example, the network may set the indicator as permitting the immediate access if the load on the RACH is light. Otherwise, if the load on the RACH is heavy, the network may indicate that the immediate access is not allowed. The UE is configured to check the indication before transmitting the first preamble of every RACH message and act accordingly.

If the SIB does not include the indicator as described above, the UE may be configured to determine whether to perform the persistence test based on other system parameters received. For example, the UE may decide to skip the persistence test if the persistence value Pᵢ of the current ASC selection is higher than a predefined persistence value PB. A high Pᵢ (Pᵢ close to 1) usually indicates that the network load is light.

Therefore, it is less likely to cause collision even if the persistence test is skipped.

### FIFTH EMBODIMENT OF THE INVENTION

In a fifth embodiment of the invention, the UE is allowed to start a first RACH preamble transmission immediately, if a preparatory persistence test after the last RACH transmission by the same UE is successful. The UE is configured to perform a preparatory persistence test at each RACH time slot. The UE may not use the current RACH time slot for transmission due to the lack of need for the transmission, but the result of the persistence test is recorded. If any of the preparatory persistence tests was successful, the UE can start the RACH transmission immediately, even if the load on the RACH generated by all the UEs collectively is high.

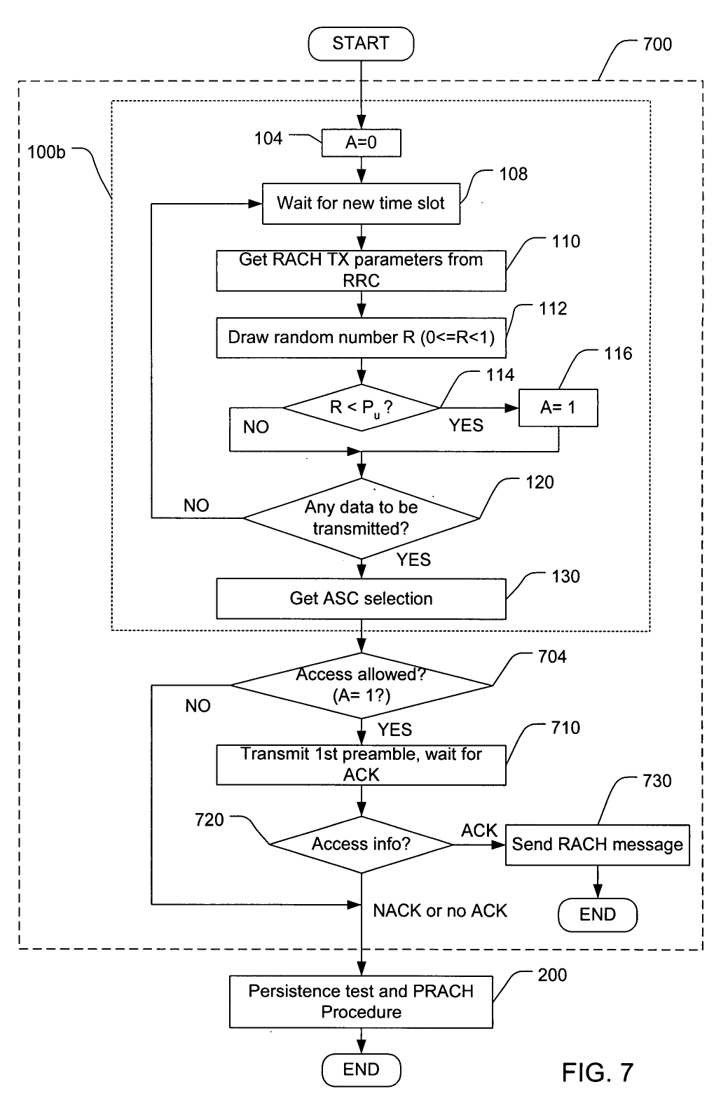

Referring now to FIG. 7, an immediate RACH transmission procedure according to this embodiment of the invention comprises a modified RACH set up procedure 700 and the persistence test and PRACH transmission procedure 200. The modified RACH set up procedure 700 comprises a procedure 100b. The procedure 100b is modified based on the above-described RACH setup procedure 100, with additional action steps that form one or more preparatory persistence tests. In the procedure 100b, first, an indicator A is set to zero (step 104). The MAC waits for the next time slot (step 108). In a step 110, the MAC receives RACH transmission parameters via the SIB. A preparatory persistence test is performed at this point. In a step 112, a random number R (0≦R<1) is generated. In a step 114, the random number R is compared with a persistence value Pᵤ. (Pᵤ may be pre-defined or provided in the system information broadcast.) If R>Pᵤ, the preparatory persistence test fails. Otherwise, if R≦Pᵤ, the preparatory persistence test succeeds. If the preparatory persistence test is successful, in a step 116, the indicator A is changed from 0 to 1.

Even if the preparatory persistence test is successful, the UE may not use the current RACH time slot for transmission due to the lack of need for the transmission. If the preparatory persistence test has failed and there is no need for the RACH transmission, the UE waits for the next time slot and starts a new preparatory persistence test (back to step 108).

Between the preparatory persistence tests, the MAC checks if there is a need for transmitting data on the RACH (step 120). If there is a need to transmit, in a step 130, the MAC selects (or the RRC assigns) an ASC from the available set of ASCs and proceeds with either an immediate transmission of a RACH preamble or the persistence test and PRACH transmission procedure 200.

In a step 704, the decision of whether to immediately transmit a RACH preamble or proceed with the persistence test and PRACH transmission procedure 200 is based on the value of the indicator A. If A=1, the immediate access is allowed. In a step 710, the first RACH preamble is transmitted at the immediately available time slot that is allocated for transmitting the preamble, and the MAC waits for a response on the downlink indicator channel. In a step 720, the MAC determines if the response is a positive acknowledgement (ACK), a negative acknowledgement (NACK) or no acknowledgement (no ACK). If there is an ACK, a time slot is allocated for transmitting the message body. In a step 730, the MAC transmits the RACH message body at the time slot that is allocated for the RACH message body, reports to the higher layer that originated the RACH transmission that the transmission was successful and the immediate RACH access procedure ends. Otherwise, if there is a NACK (i.e. the channel is busy) or no response from the channel (no ACK), the MAC initiates the persistence test and PRACH transmission procedure 200.

If A=0, the immediate access is not allowed. The MAC initiates the persistence test and PRACH transmission procedure 200.

In this embodiment of the invention, the condition for skipping the persistence test is not deterministic. The possibility for a UE to make an immediate RACH transmission varies randomly. This procedure may reduce the possibility of a UE to create a high load on the RACH, even if the UE has many pending needs to transmit on the RACH. The use of preparatory persistency tests scales the limiting effect according to the rate of the RACH time slots.

This embodiment may be modified in various ways by people skilled in the art. For example, the preparatory persistence tests may be performed less than once in every time slot. For this purpose, a counter n may be used. The counter n represents the number of time slots that has passed without a RACH transmission (n may start from 0 and increments by one every time a new time slot appears). When there is data to be transmitted, a random number R is generated and this number is used in a preparatory persistence test in comparison with a variable persistence value Pᵥ. Pᵥ may be calculated by using the following formula:

Pᵥ=1−(1−Pᵤ)ⁿ

If R>Pᵥ, the preparatory persistence test is not successful and the indicator A is still zero. If R≦Pᵥ, the indicator A is set to 1.

Besides the above-described procedures, this invention also provides an apparatus and a network entity for performing the procedures. Such an apparatus may be a user equipment (UE) device configured to transmit a RACH message comprising one or more preambles and a message body to a network entity by using the above-described immediate RACH assess procedures. The UE device may be a wireless communication device.

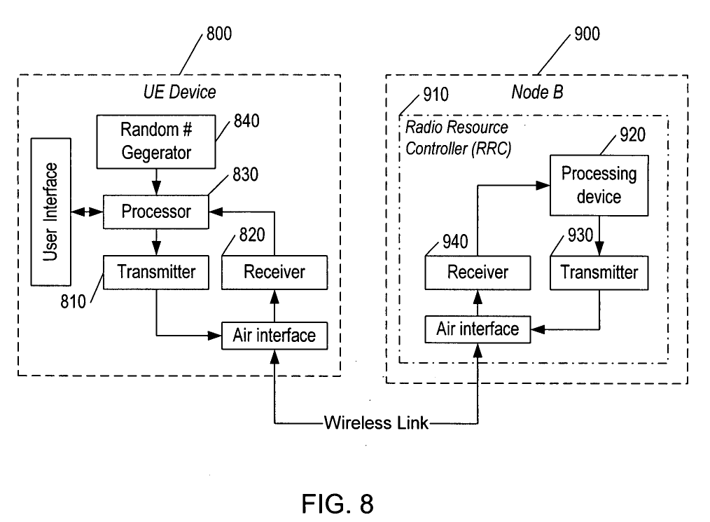

As shown in FIG. 8, an exemplary UE device 800 of the invention comprises a transmitter 810, a receiver 820, a processor 830 and a random number generator 840. The UE device 800 is configured to transmit a RACH message preamble through the transmitter 810, receive a response on an downlink indicator channel through the receiver 820, and transmit the RACH message body through the transmitter 810 if the acknowledgement is a positive acknowledgment.

The UE device 800 may use the processor 830 for determining whether it is allowed to transmit a first RACH preamble at an immediately available RACH access time slot after a need for transmission a RACH message has emerged and prior to transmitting such a preamble. The processor 830 determines that the first preamble is always transmitted, or it makes the determination based on whether a persistence value the UE device 800 received from the network entity is larger than a predetermined persistence value, whether the UE device has not transmitted on the RACH for longer than a predetermined time period, or whether the UE device has not on the RACH for longer than a random time period. The random time period is generated by the random number generator 840.

The network entity may include an indication in a system information broadcast to instruct the UE device whether or not to transmit the first RACH preamble immediately after the need for transmitting a RACH message has emerged. If such an indicator is included in the system information broadcast, the processor 830 makes the determination based on the received indication.

The processor 830 may be further configured to perform one or more preparatory persistence tests, and determine whether to transmit the preamble based on the result of the preparatory persistence tests. The processor 830 first sets a parameter A as not allowing transmitting the preamble, the random number generator 840 generates a random number, the processor 830 compares the random number with a predetermined persistence value, it sets the parameter A as allowing transmitting the preamble if the random number is less than the predetermined persistence value. The generating of the random number and comparing with the predetermined persistence value are repeated for each time slot associate with the random access channel if there is no message needs to be transmitted.

The network entity for communicating with the UE device 800 on a random access channel may be a radio resource controller 910 of a base station 900. The radio resource controller 910 may comprise a processing device 920 for configured to set a parameter according to one or more conditions of the random access channel, a transmitter 930 for transmitting the parameter as a part of a system information broadcast, and transmitting to the user equipment device 800 the acknowledgement of the first preamble on another channel, and a receiver 940 for receiving the first preamble of the message on a random access channel and for receiving the message body after an acknowledgement to the first preamble.

This invention also provides a communication system capable of operation according to the procedures provided by the above embodiments of the invention. The system comprises the network entity 910 and the user equipment device 800.

A computer program product embodying computer readable medium with program codes stored thereon is provided for use in the user equipment device 800 for transmitting a message from the user equipment device 800 to the network entity 910 on a random access channel. The computer program product comprises instructions for determining whether it is allowed to transmit the first preamble of the message to the network entity in an immediately available access time slot of a random access channel, instructions for transmitting a preamble to the network entity 910 if the transmission is allowed, and instructions for transmitting the message body if a positive acknowledgement to the preamble is received from the network entity 910 on another channel.

The determining whether it is allowed to transmit the first preamble to the network entity may be based on a parameter determined by a preparatory persistence test, and the computer program product further comprises instructions for performing one or more preparatory persistence tests prior to determining whether to transmit the preamble based on the parameter.

In summary, this invention provides an improved method for transmitting a message comprising preambles and a message body on a contention-based channel such as a RACH. The method enables a user equipment device to transmit an initial preamble of the message on the contention-based channel without performing a persistence test in order to determining if such transmission is allowed. Furthermore, the method also allows for deciding when it is reasonable to access the contention-based channel without the persistence test preceding the first preamble. The implementation of the immediate access to the contention-based channel, as described above, will not significantly increase the load on the channel. If the load on the channel is heavy, the network can respond by directing the user equipment device to not skip the persistence test, or to adjust the persistence value P and vary the rate of the access time slot.

The advantages of the invention include reducing the access delay to the RACH in either a light traffic load on the RACH or if the UE has not transmitted for some time, or both. When used properly, this invention may reduce average waiting period for a UE to send messages on the RACH.

Although the invention is illustrated in connection with the FDD mode under E-UTRAN, it is understood that the invention is also applicable to other modes of operation such as time division duplexing (TDD) or other wireless communication platforms such as UTRAN. For instance, in other systems, a concept of back-off window may have been used instead of the persistency test. The concept of the invention is also directly applicable to the concept of the back-off window. Further, the concept of the invention is also directly applicable to systems where the random access procedure does not include a separate preamble that must be acknowledged before sending the actual random access message. If the complete random access message is sent on the contention-based channel, retransmissions of the message, following a failure, may be treated the same way as the retransmissions of the preambles.

The present invention has been disclosed in reference to specific examples therein. Numerous modifications and alternative arrangements may be devised by those skilled in the art without departing from the scope of the present invention.

The invention claimed:

1. A method for transmitting a message comprising one or more preambles and a message body, said method comprising:
determining whether it is allowed to transmit a first preamble of the message from a user equipment device to a network entity in an immediately available access time slot of a random access channel,
transmitting the first preamble if the transmission is allowed, and
transmitting the message body if a positive acknowledgment to the preamble is received from the network entity on another channel.

2. The method of claim 1, wherein the determining whether it is allowed to transmit the first preamble comprises allowing to transmit the first preamble invariably.

3. The method of claim 1, wherein the determining whether it is allowed to transmit the first preamble comprises
allowing to transmit the first preamble if the user equipment device has not transmitted on the random access channel for longer than a predetermined time period, or
allowing to transmit the first preamble if the user equipment device has not transmitted on the random access channel for a number of access time slots of the random access channel that is greater than a predetermined number.

4. The method of claim 1, further comprising:
generating a random time period or a random integer, wherein the determining whether it is allowed to transmit the first preamble comprises
allowing to transmit the first preamble if the user equipment device has not transmitted on the random access channel for longer than the random time period, or
allowing to transmit the first preamble if the user equipment device has not transmitted on the random access channel for a number of access time slots that is greater than the random integer.

5. The method of claim 1, further comprising:
receiving a persistence value from the network entity,
wherein the determining whether it is allowed to transmit the first preamble comprises allowing to transmit the first preamble if the received persistence value is larger than a predetermined persistence value.

6. The method of claim 1, further comprising:
receiving an indicator from the network entity,
wherein the determining whether it is allowed to transmit the first preamble comprises determining whether it is allowed to transmit the first preamble based on the indicator.

7. The method of claim 1, further comprising:
performing one or more preparatory persistence tests prior to determining whether to transmit the first preamble,
wherein a parameter is determined by the one or more preparatory persistence tests,
and wherein the determining whether it is allowed to transmit the first preamble comprises determining whether it is allowed to transmit the first preamble based on the parameter.

8. The method of claim 7, wherein performing one or more preparatory persistence tests comprises:
setting the parameter as not allowing transmitting the first preamble,
generating a random number,
comparing the random number with a predetermined persistence value,
setting the parameter as allowing transmitting the first preamble if the random number is less than the predetermined persistence value, and
repeating generating the random number and comparing with the predetermined persistence value for each access time slot of the random access channel if no message needs to be transmitted.

9. An apparatus capable of transmitting a message comprising one or more preambles and a message body, said apparatus comprising:
a processor for determining whether it is allowed to transmit a first preamble of the message to a network entity in an immediately available access time slot of a random access channel,
a transmitter for transmitting the first preamble if the transmission is allowed, and transmitting the message body if a positive acknowledgement to the first preamble is received, and
a receiver for receiving the acknowledgement from the network entity on another channel.

10. The apparatus of claim 9, wherein the processor is configured to allow transmitting the first preamble invariably.

11. The apparatus of claim 9, wherein the processor is configured to allow transmitting the first preamble if the apparatus has not transmitted on the random access channel for longer than a predetermined time period or if the apparatus has not transmitted on the random access channel for a number of access time slots of the random access channel that is greater than a predetermined number.

12. The apparatus of claim 9, further comprising:
a random number generator for generating a random time period or a random integer,
wherein the processor is configured to allow transmitting the first preamble if the apparatus has not transmitted on the random access channel for longer than the random time period or if the apparatus has not transmitted on the random access channel for a number of access time slots of the random access channel that is greater than the random integer.

13. The apparatus of claim 9, wherein the receiver is configured to receive a persistence value from the network entity, and wherein the processor is configured to allow transmitting the first preamble if the received persistence value is larger than a predetermined persistence value.

14. The apparatus of claim 9, wherein the receiver is configured to receive an indicator from the network entity, and wherein the processor is configured to determine whether it is allowed to transmit the first preamble based on the indicator.

15. The apparatus of claim 9, wherein the processor is configured to perform one or more preparatory persistence tests prior to determining whether it is allowed to transmit first preamble, wherein a parameter is determined by the one or more preparatory persistence tests, and wherein the processor is configured to determine whether it is allowed to transmit the first preamble based on the parameter.

16. The apparatus of claim 15, further comprising a random number generator, wherein the one or more preparatory persistence tests comprising:
setting the parameter as not allowing transmitting the first preamble,
generating a random number by the random number generator,
comparing the random number with a predetermined persistence value,
setting the parameter as allowing transmitting the first preamble if the random number is less than the predetermined persistence value, and
repeating generating the random number and comparing with the predetermined persistence value for each access time slot of the random access channel if no message needs to be transmitted.

17. The apparatus of claim 9, wherein the apparatus is a user equipment device.

18. A network entity for receiving a message comprising one or more preambles and a message body, said network entity comprising:
a processing device configured to set a parameter according to one or more conditions of the random access channel,
a receiver for receiving from a user equipment device a first preamble of the message on a random access channel and for receiving the message body after an acknowledgement to the first preamble, and
a transmitter for transmitting the parameter as a part of a system information broadcast, and transmitting to the user equipment device the acknowledgement of the first preamble on another channel,
wherein the user equipment device is configured to determine whether it is allowed to transmit the first preamble in an immediately available access time slot of the random access channel based on the parameter.

19. The network entity of claim 18, wherein the parameter is a persistence value or an indicator set according to one or more conditions of the random access channel, and wherein the user equipment device is configured to allow transmitting the first preamble if the persistence value is larger than a predetermined persistence value, or wherein the user equipment device is configured to determine whether to transmit the first preamble based on the indicator.

20. A computer program product comprising a computer readable storage medium with program codes stored thereon for use in an apparatus for transmitting a message comprising one or more preambles and a message body, the program codes comprising:
instructions for determining whether it is allowed to transmit a first preamble of the message to the network entity in an immediately available access time slot of a random access channel,
instructions for transmitting the first preamble if the transmission is allowed, and
instructions for transmitting the message body if a positive acknowledgement to the preamble is received from the network entity on another channel.

21. The computer program product of claim 20, wherein the instructions for determining whether it is allowed to transmit the first preamble comprise instructions for allowing to transmit the preamble invariably.

22. The computer program product of claim 20, wherein the instructions for determining whether it is allowed to transmit the first preamble comprise instructions for allowing to transmit the first preamble, if the apparatus has not transmitted on the random access channel for longer than a predetermined time period, or if the apparatus has not transmitted on the random access channel for a number of access time slots of the random access channel that is greater than a predetermined number.

23. The computer program product of claim 20, wherein the program codes further comprise instructions for generating a random time period or a random integer, and wherein the instructions for determining whether it is allowed to transmit the first preamble comprise instructions for allowing to transmit the first preamble if the apparatus has not transmitted on the random access channel for longer than the random time period, or instructions for allowing to transmit the first preamble if the apparatus has not transmitted on the random access channel for a number of access time slots of the random access channel that is greater than the random integer.

24. The computer program product of claim 20, wherein the program codes further comprise instructions for receiving a persistence value or an indicator from the network entity, and wherein the instructions for determining whether it is allowed to transmit the first preamble comprise instructions for allowing to transmit the first preamble if the received persistence value is larger than a predetermined persistence value, or instructions for determining whether it is allowed to transmit the preamble based on the indicator.

25. The computer program product of claim 20, wherein the program code further comprise instructions for performing one or more preparatory persistence tests prior to determining whether it is allowed to transmit the first preamble, wherein a parameter is determined by the one or more preparatory persistence tests, and wherein the instructions for determining whether it is allowed to transmit the first preamble comprise instructions for determining whether it is allowed to transmit the first preamble based on the parameter.
